(19) United States
(12) Patent Application Publication
(10) Pub. No.: US 2025/0068111 A1
(43) Pub. Date: Feb. 27, 2025

(54) IMAGE FORMING APPARATUS, DETERIORATION STATE DETERMINATION METHOD, AND NON -TRANSITORY COMPUTER - READABLE RECORDING MEDIUM

(71) Applicant: Konica Minolta, Inc., Tokyo (JP)

(72) Inventors: Katsuhide Sakai, Kashiba-shi (JP); Takeshi Nomura, Toyohashi-shi (JP)

(73) Assignee: Konica Minolta, Inc., Tokyo (JP)

(21) Appl. No.: 18/786,872

(22) Filed: Jul. 29, 2024

(30) Foreign Application Priority Data
Aug. 23, 2023 (JP) 2023-135345

(51) Int. Cl. G03G 15/00; G01J 1/44

(52) U.S. Cl. CPC G03G 15/55; G01J 1/44; G03G 15/5004; G01J 2001/4473

(57) ABSTRACT

An image forming apparatus includes a detection element and a hardware processor. The detection element includes a receiving section that receives a specific signal and an output section that outputs a predetermined output value based on the specific signal received by the receiving section. The hardware processor determines in accordance with a status of an output from the output section, a state of deterioration that leads to a state in which the detection element needs to be replaced.

### CROSS REFERENCE TO RELATED APPLICATIONS

The present application is based on Japanese Patent Application No. 2023-135345 filed on Aug. 23, 2023, the contents of which are incorporated herein by reference.

### BACKGROUND OF THE INVENTION

### Technical Field

The present invention relates to an image forming apparatus, a deterioration state determination method, and a non-transitory computer-readable recording medium.

### Description of the Related Art

When an electrical device operates, electromagnetic wave noise is generated. The electromagnetic wave noise changes the characteristics of the electrical component or damages the electrical component. Therefore, electromagnetic wave noise is one of factors causing malfunction of an electric device. An image forming apparatus such as an MFP (Multifunction Peripherals) also generates electromagnetic noise during operation. In order not to affect other products in the periphery, the image forming apparatus 1s provided with a standard for suppressing the emitted electromagnetic wave noise to a predetermined amount or less. Furthermore, in order to prevent the image forming apparatus from malfunctioning or being damaged due to electromagnetic wave noise from other products, the image forming apparatus 1s also provided with a standard for resistance to electromagnetic wave noise.

Electric components mounted on the image forming apparatus also generate electromagnetic wave noise during operation or are affected by electromagnetic wave noise from the outside. The characteristics of some electrical components may gradually change under the influence of external electromagnetic wave noise. Although the characteristic changes little by little from the initial state, the user does not notice the change in the characteristic of the component and continues to use the image forming apparatus. When a user is using the image forming apparatus in such a situation, an electrical component may be malfunctioning due to the influence of electromagnetic wave noise. For example, when an electrical component malfunctions in the image forming apparatus, a job cannot be normally executed.

For example, the resistance of an electrical component such as a sensor to electromagnetic wave noise depends on whether or not the electrical component malfunctions. Whether or not a malfunction occurs is determined by whether or not the characteristics of the electrical component have changed under the influence of electromagnetic wave noise. Therefore, in order to prevent the malfunction of the electrical component, it is necessary to evaluate the characteristics of the electrical component.

Conventionally, in an image forming apparatus including multiple components, a technique has been proposed in which noise of predetermined frequencies generated from the components is detected, and the intensity of the noise is compared with a predetermined reference value stored in advance (for example, Patent Literature 1: JP1994-102724A). This conventional technology determines and provides notice of a state of another component (control circuit) based on a comparison result between the intensity of detected noise and a reference value.

The tolerance to electromagnetic wave noise varies among components. In the related art of Patent Literature 1, a state of a component is determined by detecting noise of a predetermined frequency and comparing the noise with a predetermined reference value. However, the individual difference of each component is not reflected in the predetermined reference value. Therefore, in the conventional technology, even when it is determined that there is a possibility that a failure occurs, there may be a case where no failure actually occurs. Furthermore, even in a case where it is determined that there is no possibility that a failure occurs in the related art, there may be a case where a malfunction of a component actually occurs due to a change in characteristics of the component, which leads to a failure.

### SUMMARY OF THE INVENTION

The present invention provides an image forming apparatus, a deterioration state determination method, and a non-transitory computer-readable recording medium that can solve the conventional problems described above. That is, an object of the present invention is to make it possible to appropriately determine the state of deterioration of a component due to the influence of electromagnetic wave noise even if there are individual differences in resistance to electromagnetic wave noise.

In order to achieve the above objects, firstly, the present invention is directed to an image forming apparatus.

In one aspect of the present invention, an image forming apparatus includes: a detection element including a receiving section that receives a specific signal, and an output section that outputs a predetermined output value based on the specific signal received by the receiving section, and a hardware processor. The hardware processor determines, in accordance with a status of an output from the output section, a state of deterioration that leads to a state in which the detection element needs to be replaced.

Secondly, the present invention is directed to, in an image forming apparatus including a detection element that outputs an output signal, a deterioration state determination method for determining a deterioration state of the detection element.

In one aspect of the present invention, the deterioration state determination method includes: detecting a state of the output signal; and determining, according to the state of the output signal, a deterioration state of the detection element until the detection element reaches a replacement time.

Thirdly, the present invention is directed to a non-transitory computer-readable recording medium storing a program to be executed in an image forming apparatus including a detection element that outputs an output signal.

In one aspect of the present invention, the program causes the image forming apparatus to perform: detecting a state of the output signal; and determining, according to the state of the output signal, a deterioration state of the detection element until the detection element reaches a replacement time.

### BRIEF DESCRIPTION OF THE DRAWINGS

The advantages and features provided by one or more embodiments of the invention will become more fully understood from the detailed description given herein below and the appended drawings which are given by way of illustration only, and thus are not intended as a definition of the limits of the present invention.

FIG. 1 illustrates an example of the configuration of an image forming apparatus;

FIG. 2 is a block diagram illustrating an example of a configuration for determining a deterioration state of a detection element;

FIG. 3 illustrates an example of a characteristic change of a detection element;

FIGS. 4A and 4B illustrate signals output from the comparator;

FIG. 5 illustrates a sampling result of the signal illustrated in FIG. 4B;

FIG. 6 illustrates determination content by a determiner;

FIG. 7 is a flowchart illustrating an example of a processing procedure performed by the image forming apparatus;

FIG. 8 is a flowchart illustrating an example of a detailed processing procedure of the determination processing;

FIG. 9 illustrates an example of logical determination in a case where a processing of certification that a logical value is determined is performed multiple times;

FIG. 10 is a flowchart illustrating an example of a processing procedure performed by the image forming apparatus;

FIG. 11 is a flowchart illustrating an example of a detailed processing procedure of the determination processing;

FIG. 12 illustrates an example of estimating an output current based on the mismatch occurrence number;

FIG. 13 is a flowchart illustrating an example of a processing procedure performed by the image forming apparat

FIG. 14 illustrates an example of a configuration in which multiple image forming apparatuses and a server apparatus can communicate with each other;

FIG. 15 is a block diagram illustrating an example of a configuration for determining a deterioration state of a detection element;

FIG. 16 is a block diagram illustrating an example of a configuration for determining a deterioration state of a detection element; and

FIG. 17 is a block diagram illustrating an example of a configuration for determining a deterioration state of a detection element.

### DETAILED DESCRIPTION OF THE EMBODIMENTS

Hereinafter, one or more embodiments of the present invention will be described with reference to the drawings. However, the scope of the invention is not limited to the disclosed embodiments.

Hereinafter, preferred embodiments of the present invention will be described in detail with reference to the drawings. Note that elements common to the embodiments described below are denoted by the same reference signs, and redundant description thereof is omitted.

### First Embodiment

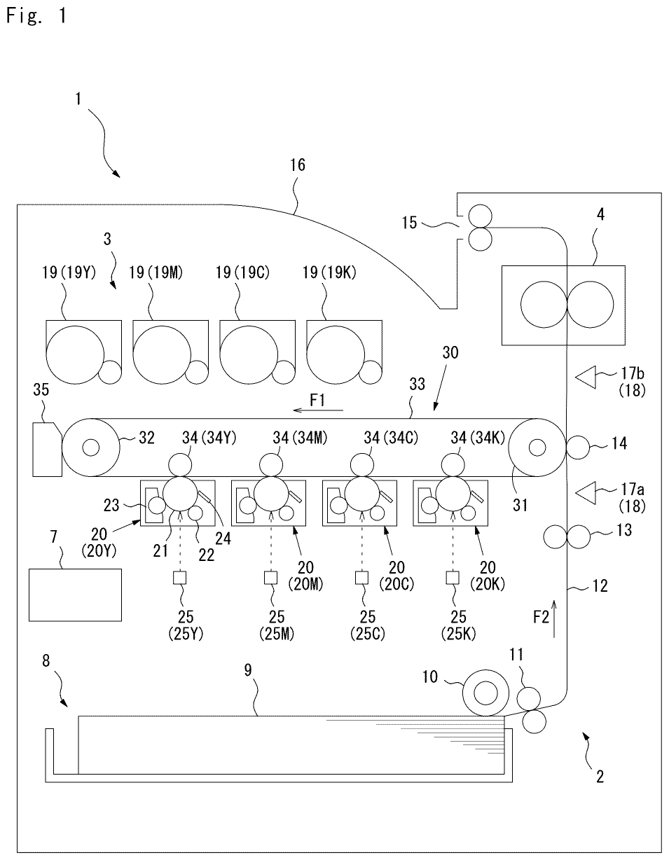

FIG. 1 illustrates an example of the configuration of an image forming apparatus 1 according to an embodiment of the present invention. An image forming apparatus 1 illustrated in FIG. 1 prints and outputs an image on a sheet 9 such as a print sheet by executing a print job designated by a user. For example, the image forming apparatus 1 forms an image on the sheet 9 by an electrophotographic method. The image forming apparatus 1 is also capable of forming a color image by a tandem system. The image forming apparatus 1 includes a conveying section 2, an image forming section 3, and a fixing section 4 inside the apparatus main body. The image forming apparatus 1 conveys sheets 9 stored in a sheet feed cassette 8 at a lower portion one by one, forms a color image or a monochrome image on the sheet 9, and discharges the sheet 9 onto a sheet exit tray 16 from a discharge port 15 at an upper portion. Further, the image forming apparatus 1 includes a controller 7 inside the apparatus main body. The controller 7 controls operation of each section, such as the conveyance section 2, the image forming section 3, and the fixing section 4.

The conveyance section 2 includes a sheet feed cassette 8, a pickup roller 10, a sheet feed section 11, a conveyance path 12, a resist section 13, and a secondary transfer section 14. The paper feed cassette 8 is a container for storing a bundle of sheets 9 such as print sheet. The pickup roller 10 picks up the topmost sheet 9 of a bundle of sheets 9 stored in the sheet feed cassette 8 and feeds the sheet to the sheet feed section 11. The sheet feed section 11 takes out only one sheet 9 positioned at the top from one or multiple sheets 9 sent out by the pickup roller 10 and supplies the sheet to the conveyance path 12 on the downstream side.

The conveyance path 12 is a path for conveying the sheet 9 in a conveyance direction indicated by an arrow F2. The sheet 9 fed to the conveyance path 12 by the sheet feeding section 11 is subjected to skew correction in the resist section 13. For example, the resist section 13 includes a pair of timing rollers. The resist section 13 corrects skew feeding of the sheet 9 by causing the leading edge of the sheet 9 to abut against a nip portion of a pair of timing rollers. After correcting the skew of the sheet 9, the resist section 13 holds the leading end of the sheet 9 at a nip portion between a pair of timing rollers. When the leading edge of the sheet 9 is held by the nip portion of the pair of timing rollers, the conveying section 2 temporarily stops the conveyance of the sheet 9. The conveying section 2 drives the pair of timing rollers in accordance with the timing at which the toner image formed by the image forming section 3 moves to the secondary transfer section 14, and conveys the sheet 9 toward the secondary transfer section 14. When the sheet 9 passes through the nip portion of the secondary transfer section 14, the toner image is transferred onto the surface of the sheet 9. The sheet 9 onto which the toner image has been transferred is then subjected to fixing processing of the toner image when passing through the fixing section 4. The fixing section 4 fixes the toner image to the sheet 9 by performing a heat and pressure processing on the conveyed sheet 9. Thereafter, the sheet 9 is discharged onto a sheet exit tray 16 from a discharge port 15.

The image forming section 3 forms toner images of four colors of Y (yellow), M (magenta), C (cyan), and K (black), and simultaneously transfers the toner images of the four colors onto the sheet 9 passing through the secondary transfer section 14. The image forming section 3 includes multiple toner bottles 19 (19Y, 19M, 19C, and 19K), multiple units 20 (20Y, 20M, 20C, and 20K), multiple exposure section 25 (hpm, gox, qmf, and taq), and a transfer unit 30. 25M 25C 25K 25Y. Each of multiple toner bottles 19 (19Y, 19M, 19C, 19K) corresponds to each colors. Further, each of multiple of image units 20 (20Y, 20M, 20C, and 20K) also corresponds to each color. Furthermore, each of multiple exposure sections 25 (25Y, 25M, 25C, and 25K) also corresponds to each color.

The transfer unit 30 is a unit in which a pair of rollers 31 and 32, an intermediate transfer belt 33, primary transfer rollers 34 (34Y, 34M, 34C, and 34K), and a cleaning section 35 are integrally assembled. The pair of rollers 31 and 32 are arranged at a predetermined interval in the horizontal direction. The intermediate transfer belt 33 is formed of an endless belt, and is disposed in a state of being stretched around the pair of rollers 31 and 32. The primary transfer rollers 34 (34Y, 34M, 34C, and 34K) are arranged at positions facing the respective image units 20 inside the intermediate transfer belt 33. The cleaning section 35 removes toner remaining on the surface of the intermediate transfer belt 33.

One roller 31 of the pair of rollers 31 and 32 is a driving roller which is mounted on a driving shaft provided inside the apparatus main body and rotates. The roller 31 circularly moves the intermediate transfer belt 33 in the direction of the arrow F1 when the drive shaft is rotationally driven. The other roller 32 is mounted on a driven shaft provided inside the apparatus main body, and is driven to rotate along with the circulating movement of the intermediate transfer belt 33. The pair of rollers 31 and 32 is installed at positions separated by a predetermined interval inside the apparatus main body in a state where the pair of rollers 31 and 32 applies constant tension to the intermediate transfer belt 33. The roller 31 is installed at a position facing the secondary transfer section 14 by being attached to a drive shaft inside the apparatus main body. The roller 31 applies a pressing force to the intermediate transfer belt 33 in a state where the intermediate transfer belt 33 is sandwiched between the roller 31 and the secondary transfer section 14. The rollers 31 nip and press the sheet 9 conveyed from the registration unit 13 between the intermediate transfer belt 33 and the secondary transfer unit 14, thereby secondary transferring the toner image formed on the surface of the intermediate transfer belt 33 to the sheet 9.

The cleaning section 35 is held in contact with the surface of the intermediate transfer belt 33 at a position facing the roller 32. The cleaning section 35 removes toner remaining on the intermediate transfer belt 33 that circulates in the direction indicated by the arrow F1. For example, the cleaning section 35 includes a cleaning member such as a cleaning blade or a cleaning brush. The cleaning section 35 has a cleaning member in contact with the surface of the intermediate transfer belt 33.

The image units 20Y, 20M, 20C, and 20K corresponding to each color are provided below the transfer unit 30. The exposure sections 25Y, 25M, 25C, and 25K corresponding to each color are provided at further lower positions of the respective image units 20Y, 20M, 20C, and 20K. The toner bottles 19Y, 19M, 19C, and 19K are disposed on top of the transfer section 30 and supply toner of each color to the image units 20Y, 20M, 20C, and 20K.

The image units 20Y, 20M, 20C, and 20K have the same configuration, and only the colors of the toners used are different. That is, each of the image units 20Y, 20M, 20C, and 20K is a unit which includes the image bearing member 21, the charging section 22, the developing device 23, and the cleaning blade 24, and in which these are integrally assembled. The image bearing member 21 is configured as a photosensitive drum. The charging section 22, the developing device 23, and the cleaning blade 24 are disposed around the image bearing member 21. Note that hereinafter, the image units 20Y, 20M, 20C, and 20K may be collectively referred to as image unit 20 when they do not need to be distinguished from one another.

The image bearing member 21 includes a photosensitive layer on a surface of a photosensitive drum. The image bearing member 21 rotates in a clockwise direction while being in contact with the intermediate transfer belt 33 to which a transfer pressure has been applied by the primary transfer roller 34 of the transfer unit 30, for example. The cleaning blade 24, the charging section 22, and the developing device 23 are arranged around the image bearing member 21 along the rotation direction thereof. The charging section 22 includes a charging roller that contacts the surface of the image bearing member 21. The charging section 22 charges the surface of the image bearing member 21 to a predetermined charge. The exposure section 25 exposes the photosensitive layer charged by the charging section 22 based on an image data. Thus, the exposure section 25 forms an electrostatic latent image on the surface of the image bearing member 21. The developing device 23 stores the toner supplied from the toner bottle 19, and supplies a developer charged by stirring the carrier and the toner to the surface of the image bearing member 21. Thus, the developing device 23 develops the electrostatic latent image with toner to form a toner image on the surface of the image bearing member 21. The toner image formed on the image carrier 21 is primarily transferred to the intermediate transfer belt 33 at a position in contact with the intermediate transfer belt 33. A bias voltage having a polarity opposite to that of the charged toner image formed on the surface of the image bearing member 21 is applied to the primary transfer roller 34. The primary transfer roller 34 primarily transfers the toner image formed on the surface of the image bearing member 21 onto the intermediate transfer belt 33 with an electrostatic force generated by the bias voltage.

Each of the image units 20Y, 20M, 20C, and 20K is interlocked with each of the primary transfer rollers 34Y, 34M, 34C, and 34K, and primarily transfers the toner image of each color to the intermediate transfer belt 33 which circularly moves in the direction of the arrow f1 while sequentially superimposing the toner images. Therefore, when the intermediate transfer belt 33 passes through the position of the most downstream image unit 20K, a color image in which toner images of four colors are superimposed is formed on the intermediate transfer belt 33. Note that in the case of forming a monochrome image on the sheet 9, the image units 20Y, 20M, and 20C do not operate, and only the image unit 20K corresponding to K (black) operates, so that a monochrome image is formed with only the toner of K on the intermediate transfer belt 33.

When the toner image formed on the intermediate transfer belt 33 passes through a position facing the secondary transfer section 14, the toner image comes into contact with the sheet 9 conveyed by the conveying section 2 and is secondary transferred onto the surface of the sheet 9. The secondary transfer section 14 is provided at a position facing the roller 31 with the intermediate transfer belt 33 interposed therebetween. When the toner image primarily transferred to the intermediate transfer belt 33 contacts the sheet 9, a bias voltage having a polarity opposite to that of the charged toner is applied to the secondary transfer section 14. Thus, the toner image can be secondary transferred to the sheet 9.

Even after the toner image is secondary transferred onto the sheet 9 at the position of the secondary transfer section 14, a part of toner may remain on the surface of the intermediate transfer belt 33. Such residual toner is circulated and moved together with the intermediate transfer belt 33 while adhering to the surface of the intermediate transfer belt 33. Then, when the residual toner passes through the position of the cleaning section 35, the residual toner is removed from the surface of the intermediate transfer belt 33 by a cleaning member provided in the cleaning section 35.

Furthermore, toner may remain on the surfaces of the image bearing members 21 even after the toner images formed on the image bearing members 21 in the image units 20Y, 20M, 20C, and 20K are primarily transferred onto the intermediate transfer belt 33. Such residual toner moves toward the cleaning blade 24 as the image bearing member 21 rotates, and is removed from the surface of the image bearing member 21 by the cleaning blade 24.

A sheet detection sensor 17a and a loop detection sensor 17b are provided on a conveyance path 12 along which the sheet 9 is conveyed. The sheet detection sensor 17a is provided between the resist 13 and the secondary transfer section 14 and in the vicinity of the conveyance path 12. The sheet detection sensor 17a is a sensor that detects passage of the sheet 9 on the downstream side of the resist 13. The loop detection sensor 17b is provided between the secondary transfer section 14 and the fixing section 4 and in the vicinity of the conveyance path 12. The loop detection sensor 17b is a sensor that detects, at a predetermined position on the upstream side of the fixing section 4, whether or not a moderate loop (bend) is formed in the sheet 9 guided to the fixing section 4. The sheet detection sensor 17a and the loop detection sensor 17b are both detection element 18 that detect a specific state in the image forming apparatus 1. The sheet detection sensor 17a and the loop detection sensor 17b are set to output a signal indicating a predetermined value when a specific state is detected.

FIG. 1 illustrates an example in which the image forming apparatus 1 includes two detection element 18. However, the number of detection element 18 mounted on the image forming apparatus 1 is not limited to two. That is, the image forming apparatus 1 is provided with a large number of detection elements 18 for detecting various states in the image forming apparatus 1. The large number of detection elements 18 are all formed of electrical components. Therefore, the characteristics of the detection element 18 gradually change under the influence of the electromagnetic wave noise. When the characteristics change, the detection element 18 may malfunction. When the image forming apparatus 1 is executing a job, a malfunction of the detection element 18 may cause troubles such as a jam and an error. Therefore, the image forming apparatus 1 of the present embodiment is configured to determine the deterioration state of the detection element 18 due to the influence of the electromagnetic wave noise. An example of a configuration for determining the deterioration state of the detection element 18 will be described in detail below.

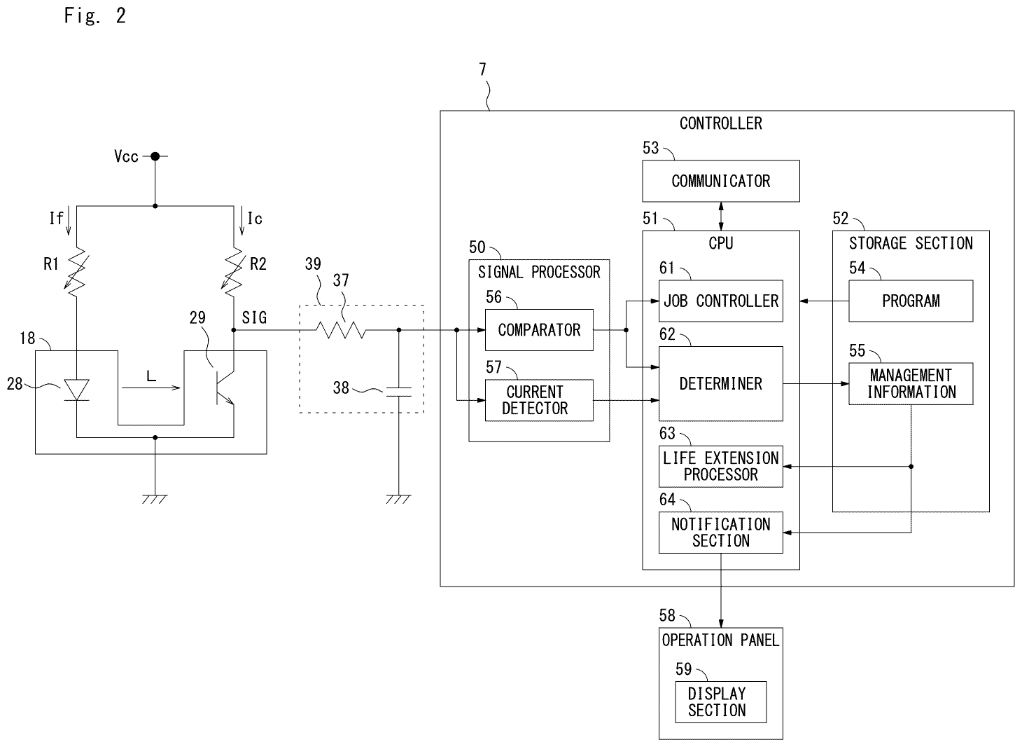

FIG. 2 is a block diagram illustrating an example of a configuration for determining the state of deterioration of the detection element 18. The detection element 18 according to the present embodiment is formed with a photo interrupter which is, for example, a transmission-type photosensor. The detection element 18 includes a light projector 28 and a light receiver 29. The light projector 28 is configured by a light emitting element such as an LED. The light receiver 29 is formed of a light receiving element such as a phototransistor. The light projector 28 emits the light L toward the light receiver section 29. When no shielding object exists between the light projector 28 and the light receiver 29, the light L from the light projector 28 is received by the light receiver 29. When a shielding object exists between the light projector 28 and the light receiver 29, the light L from the light projector 28 is shielded by the shielding object. In this case, the light receiver 29 does not receive the light L from the light projector 28. Therefore, the light receiver 29 of the detection element 18 functions as a receiver that receives, as a specific signal, the light applied from the light projector 28.

An anode of the light projector 28 is connected to a power source Vcc via a pull-up resistor R1. For example, the pull-up resistor R1 is a variable resistor whose resistance value can be changed under the control of the controller 7. A cathode of the light projector 28 is connected to the ground. Therefore, the current If flows constantly through the light projector 28, and the light projector 28 enters a light emitting state.

The collector of the light receiver 29 is connected to a power supply Vcc via a pull-up resistor R2. For example, the pull-up resistor R2 is a variable resistor whose resistance value can be changed under the control of the controller 7. An emitter terminal of the light receiver 29 is connected to the ground.

In the detection element 18, when a shielding object exists between the light receiver 28 and the light receiver 29, the phototransistor of the light receiver 29 is turned off. At this time, the voltage of the collector terminal of the light receiver 29 becomes HIGH. On the other hand, in the detection element 18, when no obstacle exists between the light receiver 28 and the light receiver 29, the phototransistor of the light receiver 29 is turned on. At this time, an output current Ic flows through the phototransistor. Therefore, the voltage of the collector terminal of the light receiver 29 becomes LOW. Therefore, the light receiver 29 of the detection element 18 functions as an output section that outputs an output signal indicating a predetermined output value based on the received specific signal.

For example, in a case where the detection element 18 is the sheet detection sensor 17a, when the sheet 9 enters between the light projector 28 and the light receiver 29, the detection element 18 detects the sheet 9 and outputs the signal SIG corresponding to the current Ic. Further, in a case where the detection element 18 is the loop detection sensor 17b, when a blocking object enters between the light projector 28 and the light receiver 29 due to the loop formation of the sheet 9, the detection element 18 detects the loop formation state and outputs the signal SIG corresponding to the current Ic.

A low-pass filter 39 including a resistor 37 and a capacitor 38 is connected to an output terminal (collector terminal) of the detection element 18. An output terminal of the low-pass filter 39 is connected to the controller 7. However, whether or not the low-pass filter 39 is provided between the detection element 18 and the controller 7 is arbitrary.

The controller 7 includes a signal processor 50, a CPU51, a storage section 52, and a communicator 53. The signal processor 50 is formed with an arithmetic circuit such as an application specific integrated circuit (ASIC). The CPU51 is a hardware processor that reads and executes the program 54 stored in the storage section 52. The CPU51 comprehensively controls execution operation of jobs in the image forming apparatus 1. Furthermore, the CPU51 determines the deterioration state of the detection element 18. The storage section 52 is a nonvolatile storage device constituted by a hard disk drive (HDD), a solid state drive (SSD), or the like. The storage section 52 stores a program 54 to be executed by the CPU51. Furthermore, the storage section 52 stores management information 55 in which the state of the detection element 18 is recorded. The communicator 53 is an interface for connecting the image forming apparatus 1 to a network to communicate with an external apparatus.

The image forming apparatus 1 includes an operation panel 58. The operation panel 58 is a user interface for a user to operate the image forming apparatus 1. The operation panel 58 includes a display section 59. The display section 59 is configured by, for example, a color liquid crystal display. For example, the display section 59 displays an operation screen that can be operated by a user. The display section 59 also displays various notification screens for the user.

The signal processor 50 processes the output signal SIG output from the detection element 18. The signal processor 50 includes a comparator 56 and a current detector 57.

The comparator 56 compares the output signal SIG output from the detection element 18 with a predetermined threshold value, and outputs a binary signal of HIGH or LOW. For example, when the voltage level of the output signal SIG is equal to or higher than a predetermined threshold, the comparator 56 outputs a HIGH signal. When the voltage level of the output signal SIG is lower than the predetermined threshold, the comparator 56 outputs a LOW signal. That is, the comparator 56 outputs a logical value indicating whether the output signal SIG output from the detection element 18 is larger or smaller than the threshold value.

The current detector 57 detects an output current Ic flowing through the light receiver 29 of the detection element 18. The output signal SIG output from the detection element 18 is a voltage signal corresponding to the output current Ic. Therefore, the current detector 57 is formed of, for example, an A/D converter. The current detector 57 converts the voltage signal corresponding to the output current Ic into a digital signal, thereby outputting a signal indicating the output current Ic.

CPU51 The CPU 51 functions as a job controller 61, a determiner 62, a life extension processor 63, and a notification section 64 by executing the program 54.

Job controller 61 controls execution of a job in image forming apparatus 1. For example, when the job controller 61 receives a print job via the communicator 53, the job controller 61 drives each of the conveying section 2, the image forming section 3, and the fixing section 4 to control an operation of forming an image on the sheet 9. For example, the job controller 61 controls the conveyance operation of the sheet 9 and the loop forming operation on the sheet 9 based on the signal output from the comparator 56.

The determiner 62 determines, in accordance with the state of the output signal SIG output from the detection element 18, the deterioration state of the detection element 18 that leads to a state in which the detection element 18 needs to be replaced. That is, the determiner 62 individually determines the deterioration state of the detection element 18 under the situation where the replacement timing of the detection element 18 has not been reached.

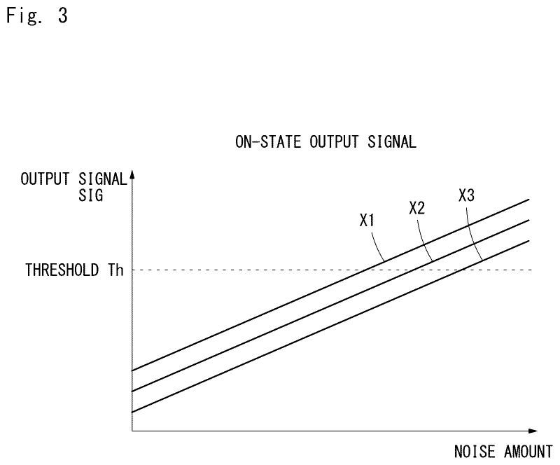

The detection element 18 gradually changes in characteristics under the influence of electromagnetic wave noise generated inside the image forming apparatus 1 or electromagnetic wave noise received from the outside of the image forming apparatus 1. FIG. 3 is a diagram illustrating an example of a characteristic change of the detection element 18. FIG. 3 illustrates a level change of the output signal SIG that is output when the detection element 18 is in the on state. As illustrated in FIG. 3, as the detection element 18 continues to receive electromagnetic wave noise, the voltage level of the output signal SIG gradually increases and approaches the threshold Th determined by the comparator 56. Further, the detection signal SIG changes in various modes such as characteristic changes X1, X2, and X3 illustrated in FIG. 3 due to individual differences of the detection element 18. For example, when the signal SIG changes in the form of the characteristic changes X1 illustrated in FIG. 3, the signal SIG exceeds the thresholds Th even in a state where the amount of noise is relatively small. On the other hand, when the signal SIG varies in the manner of the characteristic variation X3 illustrated in FIG. 3, the signal SIG does not exceed the thresholds Th unless the amount of noise becomes larger than the characteristic variation X1. Although FIG. 3 illustrates an example in which the characteristic changes X1, X2, and X3 have the same inclination, the inclination may vary depending on the individual difference of the detection element 18.

When the signal SIG in the on state exceeds the thresholds Th in constantly, the comparator 56 outputs a HIGH signal in constantly. In this case, the on state and the off state of the detection element 18 cannot be distinguished from each other by the signal output from the comparator 56. Therefore, when the detection signal SIG in the on state exceeds the thresholds Th in a constantly manner, the detection element 18 enters a failure state.

In contrast, the output signal SIG in the on state may exceed the threshold Th from time to time. In this case, the detection element 18 is in a quasi-failure state or a failure state. In this case, whether the job controller 61 can normally execute the job depends on the frequency at which the output signal SIG exceeds the threshold Th. For example, when the frequency with which the output signal SIG exceeds the threshold Th is relatively low, there are many cases where the job controller 61 can normally execute a job based on the output signal SIG from the detection element 18. Therefore, the detection element 18 is in a first quasi-fault state. On the other hand, when the frequency at which the output signal SIG exceeds the threshold Th increases, the number of cases in which the job controller 61 can normally execute a job based on the output signal SIG from the detection element 18 decreases. In this case, the detection element 18 is in a second quasi-failure state. However, when the frequency at which the output signal SIG exceeds the threshold value Th becomes extremely high, the number of cases in which the job controller 61 can normally execute a job based on the output signal SIG from the detection element 18 is greatly reduced. In this case, the detection element 18 enters a failure state. Normally, the detection element 18 changes from the normal state to the second quasi-failure state via the first quasi-failure state, and then reaches the failure state.

Furthermore, when the detection element 18 is affected by electromagnetic wave noise, the output current Ic in the on state tends to gradually decrease.

There are two methods for the determiner 62 to determine the state of degradation of the detection element 18. A first method is a method of determining the deterioration state of the detection element 18 by evaluating how close the output signal SIG of the detection element 18 is to the threshold Th. A second method is a method of measuring the output current Ic of the detection element 18. In the present embodiment, an example in which the determiner 62 determines the deterioration state of the detection element 18 by the first method will be described.

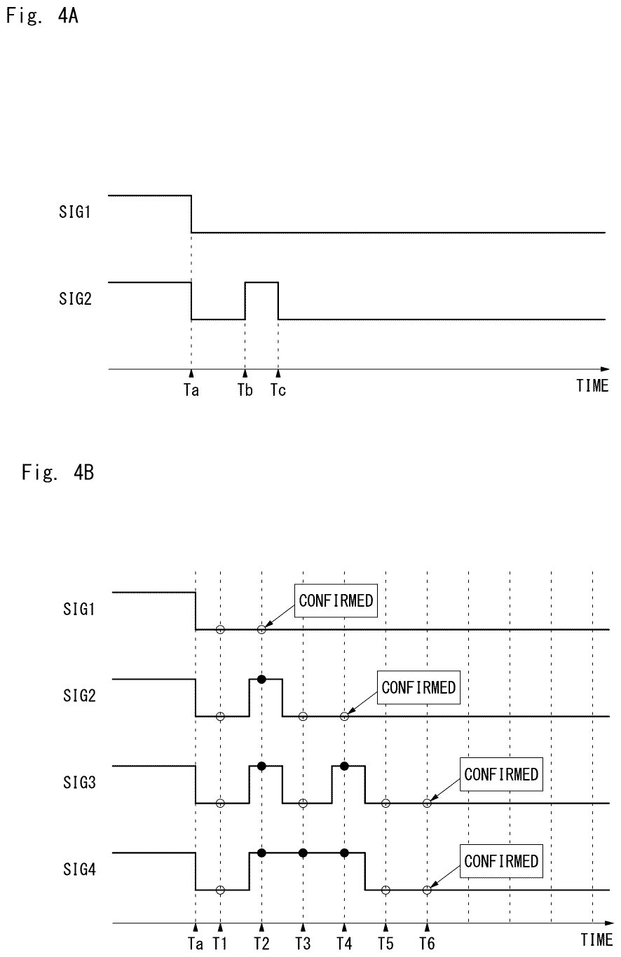

FIGS. 4A and 4B illustrate signals output from the comparator 56. A signal SIG1 illustrated in the 4A of the drawing illustrates a signal when the detection element 18 are in a normal state. When the detection element 18 is turned on at the timing Ta, the signal SIG1 is switched from HIGH to LOW. When the detection element 18 is in the normal state, the signal SIG1 output from the comparator 56 continues to output the LOW signal while the detection element 18 is in the ON state.

In contrast, a signal SIG2 illustrated in FIG. 4A illustrates a signal in a case where the detection element 18 are in a quasi-failure state. When the detection element 18 is turned on at the timing Ta, the signal SIG2 is switched from HIGH to LOW. However, since the signal SIG outputted from the detection element 18 is approaching the thresholds Th, after the signal SIG2 is switched from HIGH to LOW, the signal SIG2 outputted from the comparator 56 is switched from LOW to HIGH in response to the fluctuation of the signal SIG. In the example of FIG. 4A, the signal SIG2 is HIGH in a period from timing Tb to Tc. When the detection element 18 enters the quasi-failure state as described above, the signal SIG2 output from the comparator 56 varies after the detection element 18 enters the on state.

The determiner 62 determines the deterioration state of the detection element 18 by repeatedly performing the logical determination of the signal output from the comparator 56 in a predetermined cycle after the detection element 18 is turned on. FIG. 4B illustrates an example of the logical determination. Signals SIG1, SIG2, SIG3, and SIG4 illustrated in FIG. 4B are signals output from the comparator 56 and indicate signals in the process of the progress of the deterioration of the detection element 18.

The signal SIG1 is a signal that is output from the comparator 56 when the detection element 18 is in a normal state. When the signal SIG1 is switched from HIGH to LOW at the timing Ta, the determiner 62 repeatedly performs an operation of sampling the logical value of the signal T1 at a predetermined cycle from a predetermined timing SIG1. Note that the sampling interval is an interval of about several milliseconds. When the logical value indicating the predetermined value (LOW) is continuously sampled a predetermined number of times, the determiner 62 recognizes that the logical value of the signal SIG1 is determined to be the predetermined value. In the example of FIG. 4B, when a logical value indicating a predetermined value (LOW) can be sampled twice in a row, the determiner 62 recognizes that the logical value of the signal SIG1 is determined. In the case of the signal SIG1, the timing at which the determiner 62 determines that the logical value is determined is T2. Since the signal SIG1 is a signal when the detection element 18 is in a normal state, the number of samplings until it is recognized by the determiner 62 that the logical value is determined is the minimum “2”.

The signal SIG2 is a signal output from the comparator 56 when the detection element 18 is slightly deteriorated from the normal state. When the signal SIG2 is switched from HIGH to LOW, the determiner 62 repeatedly performs an operation of sampling the logical value of the signal T1 at a predetermined cycle from a predetermined timing SIG2. Next, similarly to the above, when the determiner 62 samples the logical value indicating the predetermined value (LOW) for a predetermined number of consecutive times, the determiner 62 recognizes that the logical value of the signal SIG2 is determined. In the example of FIG. 4B, when a logical value indicating a predetermined value (LOW) can be sampled twice in succession, the determiner 62 recognizes that the logical value of the signal SIG2 has been determined. The logical value of the signal SIG2 is inverted at the timing T2. Therefore, the logical value sampled at timing T2 is not the predetermined value (LOW), resulting in a logical mismatch. As a result, in the case of the signal SIG2, the timing at which the determiner 62 determines that the logical value is determined is a T4. Furthermore, since the signal SIG2 is a signal in a state where the detection element 18 are slightly deteriorated, the number of samplings until the determiner 62 determines that the logical value is determined is “4”.

The signal SIG3 is a signal that is output from the comparator 56 when the deterioration of the detection element 18 progresses. When the signal SIG3 is switched from HIGH to LOW, the determiner 62 repeatedly performs an operation of sampling the logical value of the signal T1 at a predetermined cycle from a predetermined timing SIG3. Next, similarly to the above, when the determiner 62 samples the logical value indicating the predetermined value (LOW) for a predetermined number of consecutive times, the determiner 62 recognizes that the logical value of the signal SIG2 is determined. In the example of FIG. 4B, when a logical value indicating a predetermined value (LOW) can be sampled twice in succession, the determiner 62 recognizes that the logical value of the signal SIG3 has been determined. The logical value of the signal SIG3 is inverted at the timing T2 and the timing T4. Therefore, the logical values sampled at the timings T2 and T4 are not the predetermined value (LOW), resulting in a logical mismatch. As a result, in the case of the signal SIG3, the timing at which the determiner 62 determines that the logical value is determined is a T6. Furthermore, since the signal SIG3 is a signal in a state where the deterioration of the detection element 18 has progressed, the number of times of sampling until the determiner 62 determines that the logical value is determined is “6”.

The signal SIG4 is a signal output from the comparator 56 when the deterioration of the detection element 18 further progresses. When the signal SIG4 is switched from HIGH to LOW, the determiner 62 repeatedly performs an operation of sampling the logical value of the signal T1 at a predetermined cycle from a predetermined timing SIG4. Next, similarly to the above, when the determiner 62 samples the logical value indicating the predetermined value (LOW) for a predetermined number of consecutive times, the determiner 62 recognizes that the logical value of the signal SIG4 is determined. In the example of FIG. 4B, when the logical value indicating the predetermined value (LOW) can be sampled twice in a row, the determiner 62 recognizes that the logical value of the signal SIG4 is determined. The logical value of the signal SIG4 is inverted in a period from the timing T2 to the timing T4. Therefore, the logical values sampled at the timings T2, T3, and T4 are not the predetermined value (LOW), resulting in a logical mismatch. As a result, in the case of the signal SIG4, the timing at which the determiner 62 determines that the logical value is determined is a T6. Furthermore, since the signal SIG4 is a signal in a state where the deterioration of the detection element 18 has progressed, the number of times of sampling until the determiner 62 determines that the logical value is determined is “6”.

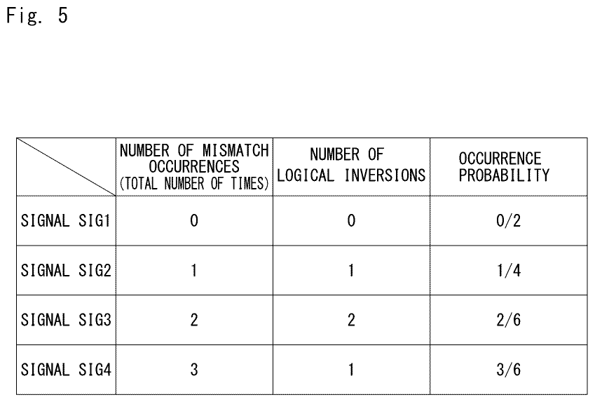

FIG. 5 illustrates sampling results of the signals SIG1 to SIG4 illustrated in FIG. 4. As illustrated in FIG. 5, in the case of the signal SIG1, the logical mismatch occurrence number becomes 0, the logical inversion number becomes 0, and the probability of logical mismatch occurrence becomes 0/2. Furthermore, in the case of the signal SIG2, the logical mismatch occurrence number is 1, the logical inversion number is 1, and the probability of logical mismatch occurrence is 1/4. Furthermore, in the case of the signal SIG3, the logical mismatch occurrence number is 2, the logical inversion number is 2, and the probability of logical mismatch occurrence is 2/6. Furthermore, in the case of the signal SIG4, the logical mismatch occurrence number is 3, the logical inversion number is 1, and the probability of logical mismatch occurrence is 3/6.

When determining the deterioration state of the detection element 18, as illustrated in FIG. 5, the determiner 62 employs at least one of the logical mismatch occurrence numbers, the logical inversion numbers, and the probability of logical mismatch as a determination criterion. For example, in a case where the logical mismatch occurrence number is used as the determination criterion, the determiner 62 determines that the detection element 18 is in the normal state when the mismatch occurrence number is 0. When the mismatch occurrence number is one or more, the determiner 62 determines that the detection element 18 is in the quasi-failure state. Furthermore, when the mismatch occurrence number is equal to or more than the predetermined number of times, the determiner 62 determines that the detection element 18 is in a failure state.

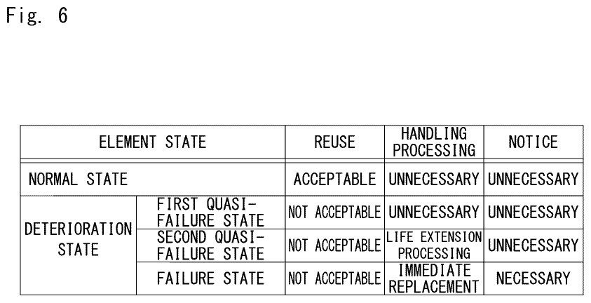

FIG. 6 is a diagram illustrating determination content by the determiner 62. The determiner 62 determines whether the state of the detection element 18 is the normal state or the deteriorated state. The deterioration state includes a first quasi-failure state, a second quasi-failure state, and a failure state. The second quasi-failure state is a state in which the deterioration state is advanced relative to the first quasi-failure state. The failure state is a state in which the deterioration state has progressed further than in the second quasi-failure state.

Upon determining the state of the detection element 18, the determiner 62 further determines, as illustrated in FIG. 6, whether the detection element 18 can be reused, countermeasure processing, and necessity of notification. When the detection element 18 is in the normal state, reuse of the detection element 18 is permitted. When reuse is permitted, the detection element 18 is reused as it is when the image forming apparatus 1 is transferred to another user. On the other hand, when reuse is prohibited, the detection element 18 is replaced with a new one when the image forming apparatus 1 is transferred to another user. In addition, in a case where the detection element 18 is in the normal state, the corresponding process for the detection element 18 is not necessary. Furthermore, in a case where the detection element 18 is in a normal state, notification to a user is also unnecessary.

When the detection element 18 is in the first quasi-failure state, the detection element 18 cannot be reused. Therefore, the detection element 18 needs to be replaced with a new one when the image forming apparatus 1 is transferred to another user. In addition, in a case where the detection element 18 is in the first quasi-failure state, the handling process for the detection element 18 is not necessary. Further, when the detection element 18 is in the first quasi-failure state, it is not necessary to notify the user.

When the detection element 18 is in the second quasi-failure state, the detection element 18 cannot be reused. When the detection element 18 is in the second quasi-failure state, the response processing for the detection element 18 is the life extension processing. The life extension processing is processing for reducing malfunction of the detection element 18. Details of the life extension processing will be described later. Further, in a case where the detection element 18 is in the second quasi-failure state, it is not necessary to notify the user.

In a case where the detection element 18 is in a failure state, the detection element 18 is not reusable. Furthermore, when the detection element 18 is in a failure state, the handling processing for the detection element 18 is immediate replacement. That is, in a case where the detection element 18 is in a failure state, it is highly likely that a job cannot be normally executed in the image forming apparatus 1, and thus the detection element 18 needs to be immediately replaced. Furthermore, in a case where the detection element 18 is in a failure state, a notification to a user is required. That is, since the detection element 18 needs to be replaced immediately, it is necessary to notify the user that maintenance work will be performed.

After making the above determination, the determiner 62 records the determination result in the management information 55. The image forming apparatus 1 is equipped with multiple detection element 18. Therefore, a determination result for each of multiple detection element 18 is individually recorded in the management information 55.

The life extension processing section 63 functions as the management information 55 is updated by the determiner 62. The life extension processing section 63 reads the management information 55 and executes the life extension processing on the detection element 18 for which the determiner 62 determines that the life extension processing is necessary. For example, the life extension processing section 63 increases the current If flowing through the light projector 28 of the detection element 18. Thus, the intensity of the light L emitted from the light projector 28 increases. When the intensity of the light L increases, the amount of light received by the light receiver 29 increases. Therefore, when the detection element 18 is turned on, the output current Ic flowing through the light receiver 29 of the detection element 18 can be increased. As a result, the amount of voltage drop in the pull-up resistor R2 increases, and the voltage level of the detection signal SIG decreases. Therefore, the operation of the detection element 18 can be brought closer to normal operation, and the life of the detection element 18 can be extended. For example, the life extension processing section 63 can increase the current If flowing through the light projector 28 by decreasing the resistance value of the pull-up resistor R1 of the light projector 28. Note that the current If flowing through the light projector 28 may be increased by a method different from this.

The notification section 64 functions in response to the management information 55 being updated by the determiner 62. The notification section 64 reads the management information 55 and executes notification processing for the detection element 18 determined to require notification by the determiner 62. For example, the notification section 64 specifies the detection element 18 to be notified based on the management information 55, and creates a notification screen that clearly indicates the specified detection element 18 and indicates to the user that immediate replacement is necessary. The notification section 64 notifies the user of the detection element 18 that needs to be immediately replaced by displaying the notification screen on the display section 59 of the operation panel 58. The notification section 64 may notify a maintenance management server installed in a service center or the like via the communicator 53 that the detection element 18 needs to be immediately replaced. Note that the notice by the notification section 64 may be a notice by sound output via a speaker.

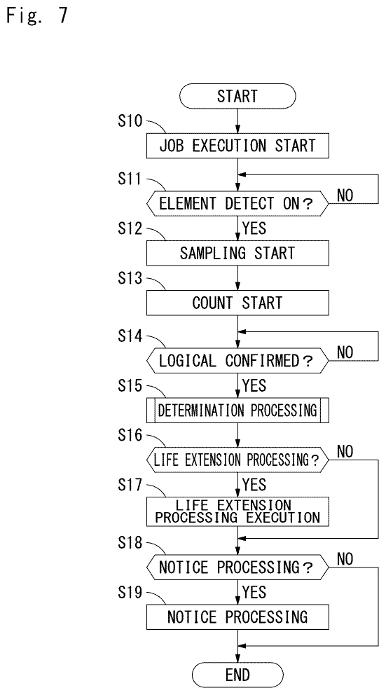

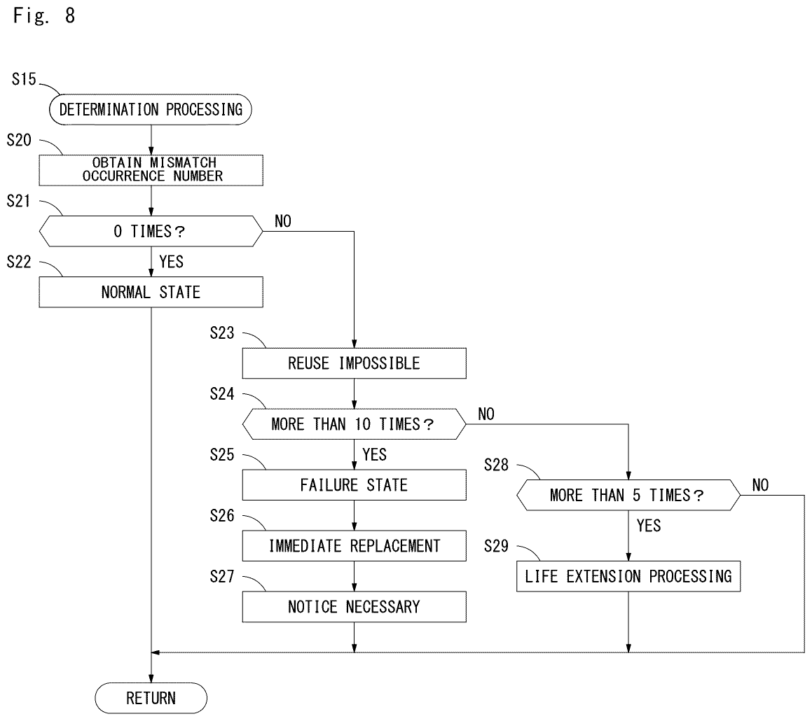

Next, operation of the image forming apparatus 1 will be described. FIGS. 7 and 8 are flowcharts illustrating an example of a processing procedure performed by the image forming apparatus 1 of the present embodiment. The processing procedure is processing procedure performed by the controller 7 when the CPU51 executes the program 54. Upon starting execution of a job in the image forming apparatus 1 (step S10), the controller 7 determines whether or not the detection element 18 have detected a particular state and have entered the on state (step S11). When the detection element 18 is turned on (YES in step S11), the controller 7 starts sampling the signal output from the comparator 56 (step S12). That is, the controller 7 starts processing of repeatedly sampling the logical value of the signal output from the comparator 56 at a predetermined cycle. When sampling is started, the controller 7 starts an operation of counting the number of times of logical mismatch in which a logical value indicates a value different from a predetermined value (step S13). The controller 7 continues the count operation until determining that the logical value of the signal output from the comparator 56 has been determined. For example, when the logical value acquired by the sampling indicates a predetermined value for multiple consecutive times, the controller 7 recognized that the logical value is determined. When the controller 7 certifies that the logical value has been determined (YES in step S14), the controller 7 executes a determination process (step S15).

FIG. 8 is a flowchart illustrating an example of a detailed processing procedure of determination processing (step S15). Upon starting the determination processing, the controller 7 acquires the counted mismatch occurrence number (step S20). Upon acquiring the mismatch occurrence number, the controller 7 determines whether or not the mismatch occurrence number is 0 (step S21). If the mismatch occurrence number is 0 (YES in step S21), the controller 7 determines that the detection element 18 is in a normal state (step S22).

If the mismatch occurrence number is not 0 (NO in step S21), it means that the signal SIG output from the detection element 18 has exceeded the thresholds Th at least once during the sampling of the logical values. In this case, the detection element 18 are in a deteriorated state, and thus the controller 7 sets the detection element 18 to be non-reusable (step S23).

Subsequently, the controller 7 determines whether or not the mismatch occurrence number is 10 or more (step S24). When the mismatch occurrence number is 10 or more (YES in step S24), the controller 7 determines that the detection element 18 is in a failure state (step S25). Further, the controller 7 determines that the detection element 18 needs to be replaced immediately (step S26). Furthermore, the controller 7 determines that it is necessary to notify to the user (step S27).

If the mismatch occurrence number is less than 10 (NO in step S24), the controller 7 determines whether or not the mismatch occurrence number is 5 or more (step S28). If the mismatch occurrence number is 5 or more (YES in step S28), the controller 7 determines that the life extension processing of the detection element 18 is necessary (step S29). In contrast, when the mismatch occurrence number is less than 5 (NO in step S28), the controller 7 determines that the response processing for the detection element 18 is unnecessary. That is, in the case of this example, the controller 7 determines that the detection element 18 is in the first quasi-failure state if the mismatch occurrence number is less than 5 times, and determines that the detection element 18 is in the second quasi-failure state if the mismatch occurrence number is 5 times or more. However, a value for distinguishing between the first quasi-failure state and the second quasi-failure state can be arbitrarily set. Thus, the determination processing (step S15) ends.

In the determination processing illustrated in FIG. 8, an example in which the deterioration state of the detection element 18 is determined based on the mismatch occurrence number has been described. However, the embodiment is not limited thereto. For example, the controller 7 may determine the deterioration state of the detection element 18 based on the logical inversion number or the mismatch occurrence probability illustrated in FIG. 5 instead of the mismatch occurrence number.

Return to the flowchart of FIG. 7. When the determination processing (step S15) is completed, the controller 7 determines whether or not to perform the life extension processing (step S16). When the controller 7 determines that the life extension processing is necessary in the determination processing, the controller 7 determines to perform the life extension processing in step S16. If the life extension processing is to be performed (YES in step S16), the controller 7 performs the life extension processing on the detection element 18 (step S17). For example, the controller 7 executes the life extension processing for the detection element 18 by increasing the current If flowing through the light projector 28. Note that when the life extension processing is not performed (NO in step S16), the processing in step S17 is skipped.

The controller 7 determines whether or not to perform notification processing (step S18). When determining in the determination processing that notice is necessary, the controller 7 determines in step S18 to perform notification processing. If the notification processing is to be performed (YES in step S18), the controller 7 executes notification processing for notifying the user that the detection element 18 needs to be immediately replaced (step S19). For example, the controller 7 notifies the user that the detection element 18 needs to be immediately replaced by displaying a notification screen on the display section 59 of the operation panel 58. Note that when the notification processing is not to be executed (NO in step S18), the processing in step S19 is skipped. Thus, the processing by the controller 7 ends.

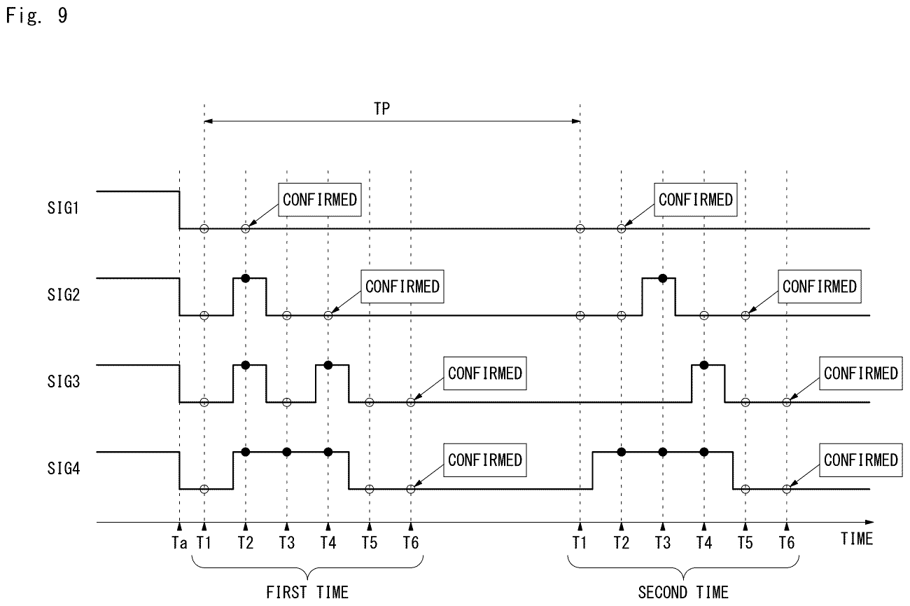

The determiner 62 may perform the processing of sampling the signal output from the comparator 56 and determining that the logical value has been determined multiple times. FIG. 9 illustrates an example of logical determination in a case where processing of certifying that the logical value is confirmed is performed multiple times. Signals SIG1, SIG2, SIG3, and SIG4 illustrated in FIG. 9 are signals output from the comparator 56 and indicate signals in a process in which the deterioration of the detection element 18 progresses. FIG. 9 illustrates an example in which the processing of sampling the signal output from the comparator 56 and determining that the logical value is determined is performed twice. In the example of FIG. 9, the second sampling is started after the predetermined time TP has elapsed from the start of the first sampling. That is, the determiner 62 repeatedly performs multiple times, detection processing for detecting a logical change until the logical value indicates the predetermined value multiple times in a row. Then, the determiner 62 calculates a mismatch occurrence probability that the logical value does not match the predetermined value in multiple times of detection processing, and determines the deterioration state of the detection element based on the mismatch occurrence probability. In this way, the determiner 62 can determine the deterioration state of the detection element 18 with higher accuracy by performing sampling multiple times after detection that the detection element 18 has transitioned to the on state.

As described above, the image forming apparatus 1 according to the present embodiment includes the detection element 18 including the receiving section that receives the specific signal and the output section that outputs the predetermined output value based on the specific signal received by the receiving section, and the determiner 62 that determines, in accordance with the status of the output value outputted from the output section of the detection element 18, the deterioration state of the detection element 18 up to the state where the detection element 18 needs to be replaced. For example, the above-described image forming apparatus 1 includes the detection element 18 that detects the specific state and outputs the predetermined output signal SIG and the determiner 62 that determines the deterioration state of the detection element 18 until the detection element 18 reaches the replacement time in accordance with the state of the output signal SIG. That is, the image forming apparatus 1 of the present embodiment monitors the signal state of the output signal SIG outputted from the detection element 18 to determine the state of deterioration of the detection element 18 that is gradually deteriorating due to electromagnetic wave noise. Therefore, the image forming apparatus 1 can appropriately determine not only whether the detection element 18 is in the normal state or in the faulty state, but also whether the detection element 18 is in the quasi-faulty state. In particular, the signal state of the output signal SIG output from the detection element 18 varies depending on the tolerance of the detection element 18 to electromagnetic wave noise. Therefore, the image forming apparatus 1 of the present embodiment can appropriately determine the deterioration state of the detection element 18 according to the individual tolerance even if there is an individual difference in the tolerance to the electromagnetic wave noise. In other words, the image forming apparatus 1 according to the present embodiment measures the tolerance of the detection element 18 to electromagnetic wave noise based on the output signal SIG, and determines the deterioration state of the detection element 18 based on the measured tolerance.

In the above description, an example in which the controller 7 performs the processing of determining the deterioration state of the detection element 18 in response to the start of execution of a job in the image forming apparatus 1 has been described. However, the controller 7 does not needs to perform the processing of determining the deterioration state of the detection element 18 every time a job is executed in the image forming apparatus 1. For example, the controller 7 may determine the deterioration state of the detection element 18 every time the number of printed sheets in the image forming apparatus 1 reaches a predetermined number of sheets. Further, the controller 7 may determine the deterioration state of the detection element 18 every time a predetermined period (for example, one month) elapses.

### Second Embodiment

Next, a second embodiment of the present invention will be described. In the first embodiment, the example in which the determiner 62 determines the deterioration state of the detection element 18 by the first method has been described. On the other hand, in a second embodiment, an example in which the determiner 62 determines the deterioration state of the detection element 18 by a second method will be described. That is, the determiner 62 of the second embodiment measures the output current Ic of the detection element 18 and determines the deterioration state of the detection element 18. The detailed configuration of the image forming apparatus 1 according to the present embodiment is the same as the configuration described in the first embodiment.

The determiner 62 of the present embodiment measures the output current Ic flowing through the light receiver 29 of the detection element 18. For example, the determiner 62 measures the output current Ic based on the signal output from the current detector 57. As described above, as the detection element 18 deteriorates due to the influence of electromagnetic wave noise, the output current Ic flowing through the light receiver 29 of the detection element 18 tends to gradually decrease. When the output current Ic decreases, the amount of voltage drop in the pull-up resistor R2 decreases, and thus the voltage level of the output signal SIG changes. That is, the output signal SIG is a signal representing the output current Ic. As described above, the current detector 57 converts the output signal SIG into a digital signal and outputs the digital signal. Therefore, the determiner 62 can calculate the output current Ic based on the signal output from the current detector 57.

Upon measuring the output current Ic, the determiner 62 determines the deterioration state of the detection element 18 based on the output current Ic. For example, the determiner 62 calculates the amount of decrease in the output current Ic from the initial state, and determines the deterioration state of the detection element 18 based on the amount of decrease. Specifically, as in the first embodiment, the determiner 62 determines which of the normal state, the first quasi-failure state, the second quasi-failure state, and the failure state the detection element 18 is in.

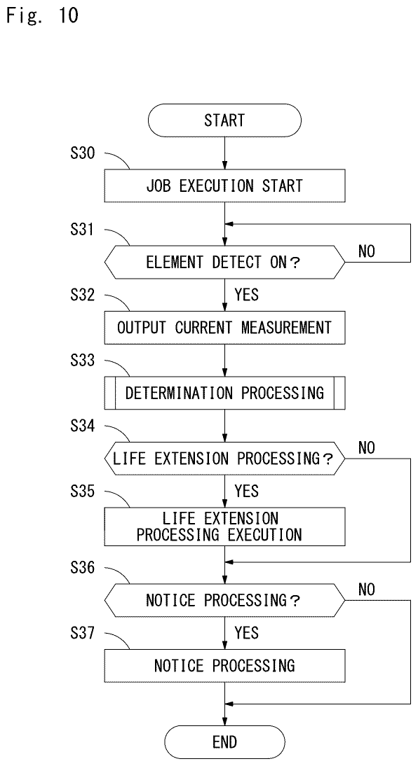

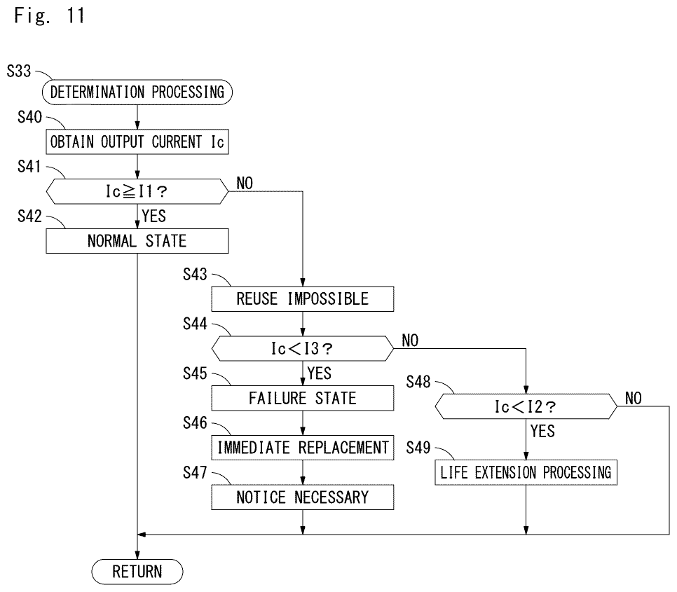

FIGS. 10 and 11 are flowcharts illustrating an example of a processing procedure performed by the image forming apparatus 1 according to the second embodiment. The processing procedure is processing procedure performed by the controller 7 when the CPU51 executes the program 54. Upon starting execution of a job in the image forming apparatus 1 (step S30), the controller 7 determines whether or not the detection element 18 has detected a particular state and have entered the on state (step S31). When the detection element 18 is turned on (YES in step S31), the controller 7 measures the current Ic flowing through the light receiver 29 of the detection element 18 (step S32). Next, the controller 7 performs determination processing (step S33).

FIG. 11 is a flowchart illustrating an example of a detailed processing procedure of determination processing (step S33). When starting the determination process, the controller 7 acquires the current Ic measured in step S33 (step S40). Next, the controller 7 determines whether or not the outputted current Ic is greater than or equal to the current I1 in the initial state (step S41). If the current Ic is equal to or larger than the current I1 (YES in step S41), the controller 7 determines that the detection element 18 is in a normal state (step S42).

On the other hand, when the current Ic is less than the current I1 (NO in step S41), the controller 7 disables the reuse of the detection element 18 (step S43). Subsequently, the controller 7 determines whether the outputted current Ic is less than a current I3 indicating a failure level (step S44). If the current Ic is less than the current I3 (YES in step S44), the controller 7 determines that the detection element 18 is in a failure state (step S45). Further, the controller 7 determines that the detection element 18 needs to be replaced immediately (step S46). Furthermore, the controller 7 determines that it is necessary to provide a notice to the user (step S47).

When the current Ic is equal to or more than the current I3 (NO in step S44), the controller 7 determines whether or not the current Ic is less than the current I2 indicating a level at which the life extension processing is required (step S48). The relationship among the currents I1, I2, and I3 is I1>I2>I3. If the current Ic is less than the current I2 (YES in step S48), the controller 7 determines that the life extension processing of the detection element 18 is necessary (step S49). On the other hand, when the current Ic is equal to or larger than the current I2 (NO in step S48), the controller 7 determines that the corresponding processing for the detection element 18 is unnecessary. That is, in the case of this example, the controller 7 determines that the detection element 18 is in the first quasi-failure state if the output current Ic is equal to or more than the current I2 and less than the current I1, and determines that the detection element 18 is in the second quasi-failure state if the output current Ic is equal to or more than the current I3 and less than the current I2. Note that the currents I1, I2, and I3 can be arbitrarily set. Thus, the determination processing (step S33) ends.

Return to the flowchart of FIG. 10. When the determination processing (step S33) is completed, the controller 7 determines whether or not to perform the life extension processing (step S34). When determining in the determination processing that the life extension processing is necessary, the controller 7 determines in step S34 to perform the life extension processing. If the life extension processing is to be performed (YES in step S34), the controller 7 performs the life extension processing on the detection element 18 (step S35). Details of the life extension processing are the same as those in the first embodiment. Note that when the life extension processing is not performed (NO in step S34), the processing in step S35 is skipped.

The controller 7 determines whether or not to perform notification processing (step S36). When determining in the determination processing that notification is necessary, the controller 7 determines in step S36 to perform notification processing. If the notification processing is to be performed (YES in step S36), the controller 7 executes notification processing for notifying the user that the detection element 18 needs to be immediately replaced (step S37). Details of the notification processing are the same as those in the first embodiment. Note that when the notification processing is not to be executed (NO in step S36), the processing in step S37 is skipped. Thus, the processing by the controller 7 ends.

As described above, the determiner 62 of the present embodiment measures the output current Ic flowing through the light receiver 29 of the detection element 18, and determines the deterioration state of the detection element 18 based on the measurement result of the output current Ic. Therefore, when the detection element 18 detects the specific state and is turned on, the determiner 62 can immediately determine the deterioration state of the detection element 18. That is, there is an advantage that the determiner 62 of the present embodiment can output the determination result earlier than the first embodiment.

Incidentally, the method of measuring the output current Ic by the determiner 62 is not limited to the method of measurement based on the signal output from the current detector 57. For example, the determiner 62 may indirectly measure the output current Ic flowing through the light receiver 29 by changing the current If flowing through the light projector 28 of the detection element 18. When changing the current If flowing through the light projector 28, the determiner 62 changes, for example, the resistance value of the pull-up resistor R1 of the light projector 28. When the current If flowing in the light projector 28 changes, the amount of light received by the light receiver 29 changes, and therefore, the output current Ic changes. Similarly to the first embodiment, the determiner 62 repeatedly samples the signal output from the comparator 56 at a predetermined cycle while changing the output current Ic. Then, the determiner 62 measures the output current Ic flowing through the light receiver 29, based on a logical change until the sampled logical value indicates the predetermined value (LOW) for multiple consecutive times. That is, the determiner 62 estimates the output current Ic based on the mismatch occurrence number in which the logical value being sampled does not match the predetermined value.

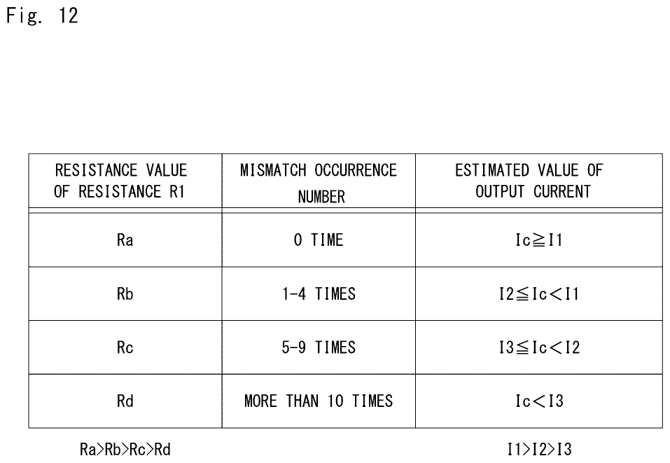

FIG. 12 is a diagram illustrating an example of estimating an output current Ic on the basis of the number of times of mismatch occurrence. As illustrated in FIG. 12, the determiner 62 changes the resistance value of the pull-up resistor R1 in the order of Ra, Rb, Rc, and Rd. Note that the relationship among the resistance values Ra, Rb, Rc, and Rd is Ra>Rb>Rc>Rd. For the resistance value Ra, if the mismatch occurrence number during sampling is 0, it is estimated that the current Ic is equal to or more than the current I1 in the initial state. For the resistance value Rb, if the mismatch occurrence number during sampling is 1 to 4, it is estimated that the current Ic is greater than or equal to the current I2 at the level requiring the life extension processing and less than the current I1. When the resistance value is Rc and the mismatch occurrence number during sampling is 5 to 9, it is estimated that the current Ic is equal to or more than the current I3 that is the failure level and is less than the current I2 that is the level at which the life extension processing is required. Furthermore, when the resistance value is Rd, if the mismatch occurrence number during sampling is equal to or more than 10, it is estimated that the current Ic is less than the current I3 which is the failure level.

The determiner 62 counts the mismatch occurrence number while changing the pull-up resistor R1 to each of the resistance values Ra, Rb, Rc, and Rd. The determiner 62 estimates the output current Ic based on the mismatch occurrence number at each of the resistance values Ra, Rb, Rc, and Rd. Then, based on the rate of change in the current Ic when the resistance value of the pull-up resistor R1 is changed, the determiner 62 calculates the current Ic when the resistance value is returned to the original value. The determiner 62 may measure the output current Ic by such a method.

Further, the determiner 62 may change the current Ic by changing the resistance value of the pull-up resistor R2 of the light receiver 29 instead of changing the current If flowing through the light projector 28 of the detector 18. The determiner 62 counts the mismatch occurrence number while changing the resistance value of the pull-up resistor R2. The determiner 62 estimates the output current Ic based on the mismatch occurrence number at each resistance value. Then, based on the rate of change in the current Ic when the resistance value of the pull-up resistor R2 is changed, the determiner 62 calculates the current Ic when the resistance value is returned to the original value. The determiner 62 may measure the output current Ic by such a method.

Configurations and operations other than those described above in the present embodiment are the same as those described in the first embodiment.

### Third Embodiment

Next, a third embodiment of the present invention will be described. In the present embodiment, an example in which the output current Ic is measured when the mismatch occurrence number is a predetermined number or more will be described. The detailed configuration of the image forming apparatus 1 according to the present embodiment is the same as the configuration described in the first embodiment.

As in the first embodiment, the determiner 62 of the present embodiment repeatedly samples the signal output from the comparator 56 at a predetermined cycle. Next, the determiner 62 determines whether or not the mismatch occurrence number in which the logical value does not match the predetermined value occurs a predetermined number or more in a period until the sampled logical value indicates the predetermined value (LOW) continuously for multiple times. When the mismatch occurrence number is equal to or greater than the predetermined number, the determiner 62 measures the output current Ic of the detection element 18 as in the second embodiment. The determiner 62 determines the deterioration state of the detection element 18 based on the measured output current Ic.

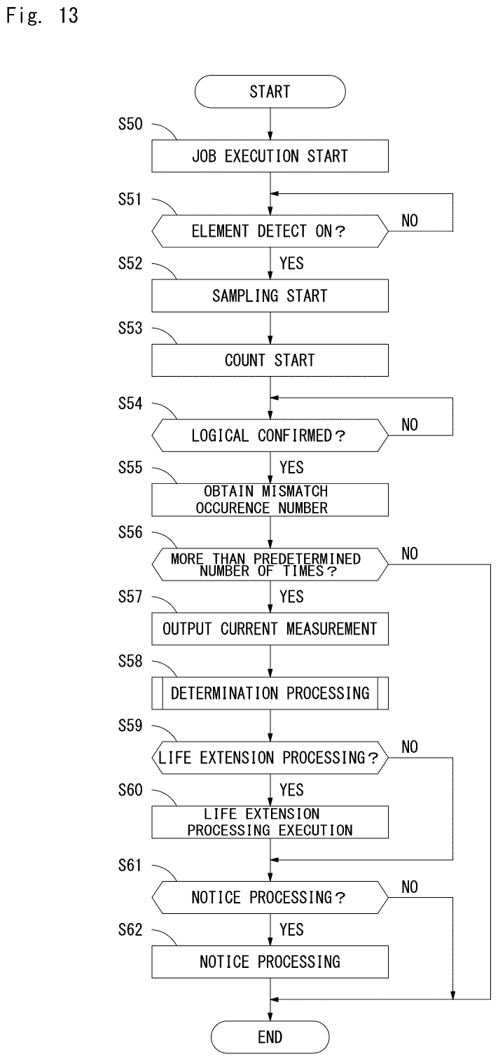

FIG. 13 is a flowchart illustrating an example of a processing procedure performed by the image forming apparatus 1 according to the third embodiment. The processing procedure is processing procedure performed by the controller 7 when the CPU51 executes the program 54. Upon starting execution of a job in the image forming apparatus 1 (step S50), the controller 7 determines whether or not the detection element 18 have detected a particular state and have entered the on state (step S51). When the detection element 18 is turned on (YES in step S51), the controller 7 starts sampling the signal output from the comparator 56 (step S52). When sampling is started, the controller 7 starts an operation of counting the mismatch occurrence number in which a logical value indicates a value different from a predetermined value (step S53). The controller 7 continues the count operation until determining that the logical value of the signal output from the comparator 56 has been determined. When the controller 7 confirmed that the logical value is determined (YES in step S54), the controller 7 acquires the mismatch occurrence number (step S55). Next, the controller 7 determines whether or not the mismatch occurrence number is a predetermined number or more (step S56). For example, the predetermined number is one. If the mismatch occurrence number is less than the predetermined number (NO in step S56), the processing by the controller 7 ends.

If the mismatch occurrence number is equal to or more than the predetermined number (YES in step S56), the controller 7 measures the current Ic flowing through the light receiver 29 of the detection element 18 (step S57). Next, the controller 7 performs determination processing (step S58). The detailed flowchart of the determination processing (step S58) is the same as the flowchart illustrated in FIG. 11.

When the determination processing (step S58) is finished, the controller 7 determines whether or not to perform the life extension processing (step S59). When determining in the determination processing that the life extension processing is necessary, the controller 7 determines in step S59 to perform the life extension processing. If the life extension processing is to be performed (YES in step S59), the controller 7 performs the life extension processing on the detection element 18 (step S60). Details of the life extension processing are the same as those in the first embodiment. Note that when the life extension processing is not performed (NO in step S59), the processing in step S60 is skipped.

The controller 7 determines whether or not to perform notification processing (step S61). When determining in the determination processing that notice is necessary, the controller 7 determines in step S61 to perform notification processing. If the notification processing is to be performed (YES in step S61), the controller 7 executes notification processing for notifying the user that the detection element 18 needs to be immediately replaced (step S62). Details of the notification processing are the same as those in the first embodiment. Note that when the notification processing is not to be performed (NO in step S61), the processing in step S62 is skipped. Thus, the processing by the controller 7 ends.

As described above, the determiner 62 of the present embodiment repeatedly samples the logical value based on the output signal SIG output from the light receiver 29 of the detection element 18 at a predetermined cycle. The determiner 62 measures the output current Ic flowing through the light receiver 29 when the number of mismatch occurrence number in which the logical value does not match the predetermined value is equal to or greater than a predetermined number in a period until the logical value continuously indicates the predetermined value multiple times. The determiner 62 determines the deterioration state of the detection element 18 based on the measurement result of the output current Ic. Thus, as in the first and second embodiments, the determiner 62 can appropriately determine which of the first quasi-failure state, the second quasi-failure state, and the failure state the detection element 18 is in.

Conversely, the determiner 62 may measure the output current Ic flowing through the light receiver 29 first. In this case, if the determiner 62 determines, based on the measurement result of the output current Ic, that the detection element 18 has deteriorated, the determiner 62 may repeatedly sample, at a predetermined cycle, the logical value based on the output signal SIG outputted from the light receiver 29 of the detection element 18. In this case, the determiner 62 determines whether the detection element 18 is in the first quasi-failure state, the second quasi-failure state, or the failure state based on the mismatch occurrence number in which the logical value does not match the predetermined value in a period until the logical value continuously indicates the predetermined value multiple times.

The configuration and operation of this embodiment other than those described above are the same as those described in the first or second embodiment.

### Fourth Embodiment

Next, a fourth embodiment of the present invention will be described. In the present embodiment, an example in which the controller 7 appropriately controls the timing of performing processing for determining the deterioration state of the detection element 18 will be described.

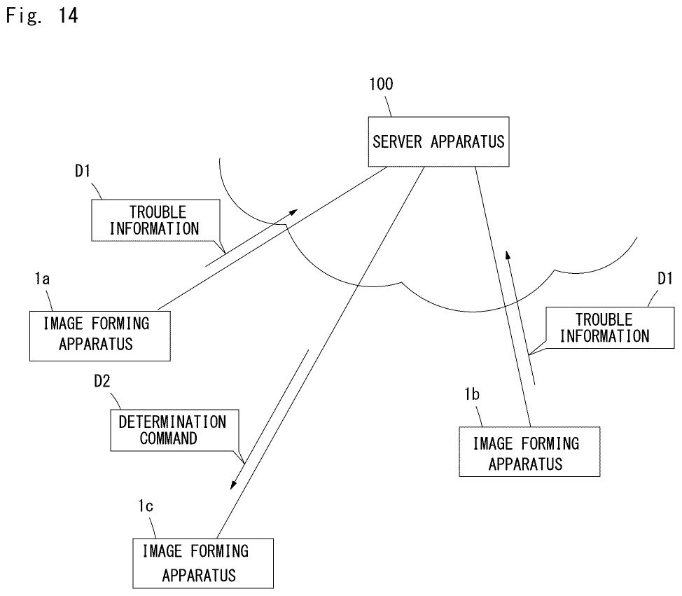

FIG. 14 is a diagram illustrating an example of a configuration in which multiple image forming apparatuses 1a, 1b, and 1c and the server apparatus 100 can communicate with each other. The server apparatus 100 communicates with each of multiple image forming apparatuses 1a, 1b, and 1c via a network such as the Internet. For example, when a trouble such as jamming occurs during execution of a job, the image forming apparatuses 1a and 1b transmit trouble information D1 to the server apparatus 100. The server apparatus 100 aggregates the trouble information D1 and analyzes the cause of the trouble occurring in the image forming apparatuses 1a and 1b. As a result, when it is determined that the cause of the trouble is deterioration of the detection element 18, the server apparatus 100 transmits a determination instruction D2 to the image forming apparatus 1a in which the same detection element 18 as that of the image forming apparatus 1b or 1c in which the trouble has occurred is mounted. Upon receiving the determination instruction D2 from the server apparatus 100, the image forming apparatus 1c starts processing for determining the deterioration state of the detection element 18.

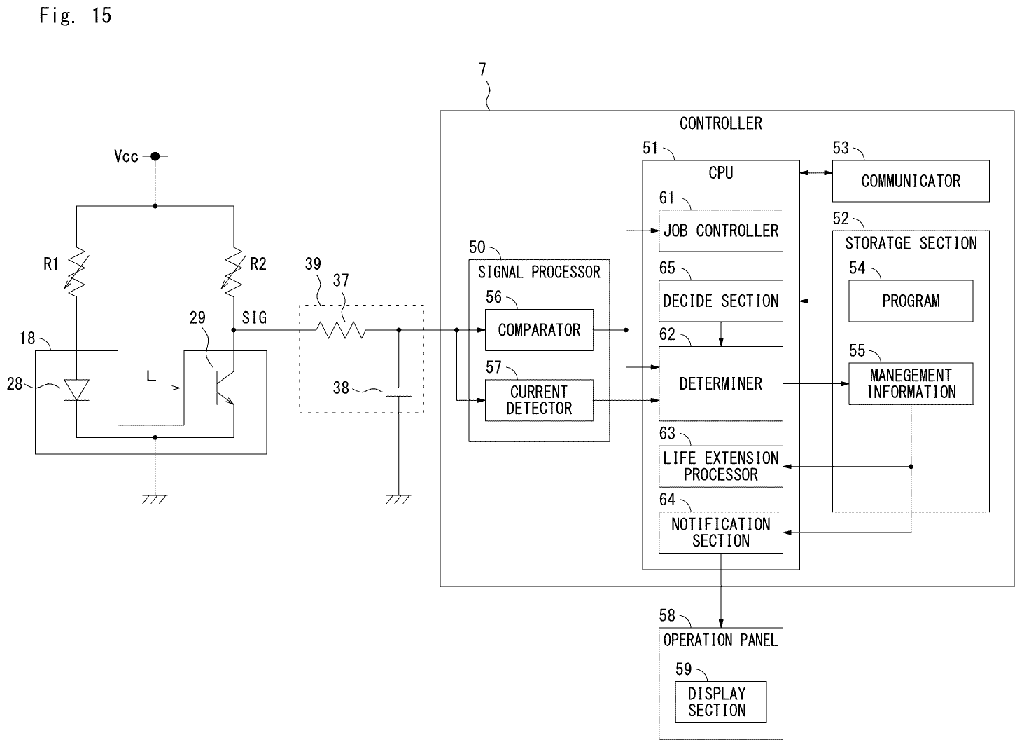

FIG. 15 is a block diagram illustrating a configuration example for determining the deterioration state of the detection element 18 in the fourth embodiment. The CPU51 of the controller 7 functions as a determiner 65 by executing the program 54. The determiner 65 determines, based on information received from the server apparatus 100 as an external apparatus, whether or not to determine the deterioration state of the detection element 18. For example, upon receiving a determination instruction D2 from the server apparatus 100, the determiner 65 decides to determine the deterioration state of the detection element 18. In this case, when the controller 7 executes a job after receiving the determination instruction D2 from the server apparatus 100, the controller 7 executes a processing of determining the deterioration state of the detection element 18. At this time, the controller 7 may execute the processing described in each of the first to third embodiments.

As described above, when a trouble occurs due to the deterioration of the detection element 18 in the other image forming apparatuses 1a and 1b, the image forming apparatus 1c in which the same detection element 18 is mounted determines the deterioration state of the detection element 18. Therefore, the image forming apparatus 1c can appropriately detect the deterioration state of the detection element 18 before a trouble due to the deterioration of the detection element 18 occurs.

Note that the example in which the server apparatus 100 transmits the determination instruction D2 to the image forming apparatus 1c, and the image forming apparatus 1c determines the deterioration state of the detection element 18 in response to reception of the determination instruction D2 has been described above. However, the present invention is not limited thereto, and the server apparatus 100 may not transmit the determination instruction 1c to the image forming apparatus D2. For example, the image forming apparatus 1c may periodically access the server apparatus 100 to inquire about the status of occurrence of trouble in the other image forming apparatuses 1a and 1b. In this case, the image forming apparatus 1c can determine, based on the response from the server apparatus 100, whether or not it is necessary to determine the deterioration state of the detection element 18. Therefore, the image forming apparatus 1c may determine the deterioration state of the detection element 18 based on the determination result.

### Fifth Embodiment

Next, a fifth embodiment of the present invention will be described. Another example in which the controller 7 appropriately controls the timing of performing the processing of determining the deterioration state of the detection element 18 will be described.

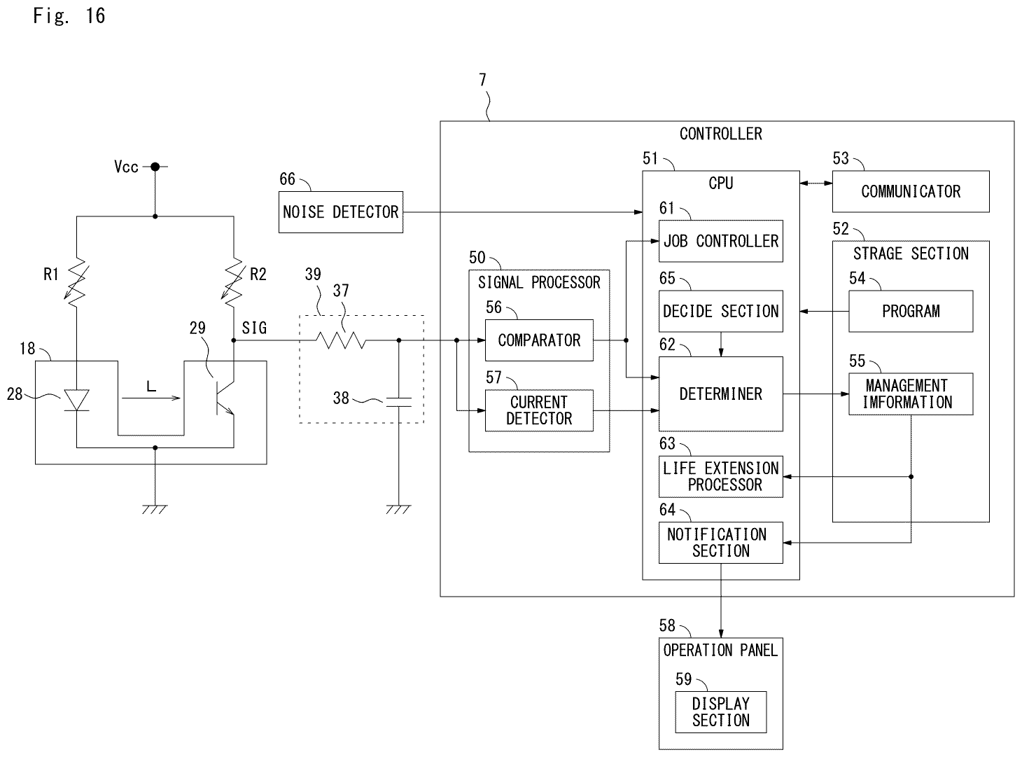

FIG. 16 is a block diagram illustrating a configuration example for determining the deterioration state of the detection element 18 in the fifth embodiment. The image forming apparatus 1 includes a noise detector 66 provided in the vicinity of the detection element 18. The noise detector 66 includes an antenna or the like that detects electromagnetic wave noise in the vicinity of the detection element 18. The CPU51 of the controller 7 functions as a determiner 65 by executing the program 54. The determiner 65 detects electromagnetic wave noise in the vicinity of the detection element 18 based on the detection result of the noise detector 66, and determines whether or not to determine the deterioration state of the detection element 18. For example, when the noise amount of the electromagnetic wave noise is greater than a predetermined amount, the determiner 65 decides to determine the deterioration state of the detection element 18. In this case, when executing a job after the determination by the determiner 65, the controller 7 executes processing of determining the state of deterioration of the detection element 18. At this time, the controller 7 may execute the processing described in each of the first to third embodiments.

Therefore, the image forming apparatus 1 according to the present embodiment can appropriately determine the deterioration state of the detection element 18 when there is a possibility that deterioration of the detection element 18 is progressing due to the effect of electromagnetic wave noise.

### Sixth Embodiment

Next, a sixth embodiment of the present invention will be described. In the present embodiment, an example will be described in which, when the deterioration state of the detection element 18 is the first quasi-failure state or the second quasi-failure state, the timing at which to prompt the user to replace the detection element 18 is controlled.

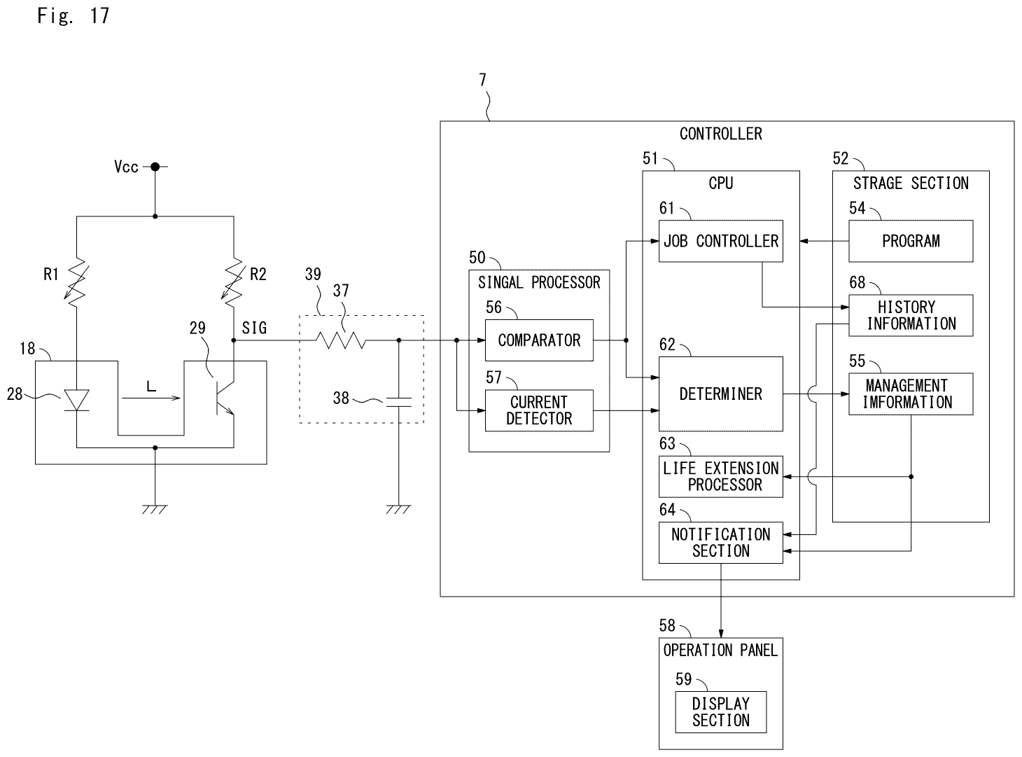

FIG. 17 is a block diagram illustrating a configuration example for determining the deterioration state of the detection element 18 in the sixth embodiment. The image forming apparatus 1 stores history information 68 including a job execution history in the storage section 52. That is, when the job controller 61 executes a job in the image forming apparatus 1, the job controller 61 generates the history information 68 including an execution history of the job and stores it in the storage section 52.

The notification section 64 reads the management information 55 and determines whether the detection element 18 is in the first quasi-failure state or the second quasi-failure state. In a case where the detection element 18 is in the first quasi-failure state or the second quasi-failure state, deterioration of the detection element 18 progresses. Therefore, in a case where the detection element 18 is in the first quasi-failure state or the second quasi-failure state, the notification section 64 reads the history information 68, and determines a timing at which the user is prompted to replace the detection element 18. Specifically, the notification section 64 identifies the frequency of use by the user based on the history information 68. In addition, the notification section 64 estimates the remaining period until the detection element 18 enters the failure state based on the use frequency of the user and the state (the first-quasi failure state or the second quasi-failure state) of the detection element 18. Then, in a case where the remaining period becomes shorter than the predetermined period, the notification section 64 performs notification for prompting the user to replace the detection element 18. Thus, the user can perform work for replacing the detection element 18 before the detection element 18 becomes faulty. Note that the notification prompting the replacement of the detection element 18 may be provided not only to the user but also to the server apparatus 100.

### Modification Example

Hereinabove, multiple preferred embodiments according to the present invention have been described. However, the present invention is not limited to the content described in each of multiple embodiments, and various modification examples are applicable.

The above embodiment has described the example in which the detection element 18 is a transmission-type photosensor. However, the detection element 18 is not limited to the transmission-type photosensor. For example, the detection element 18 may be a reflective photosensor. The detection element 18 may be formed of a sensor other than a photosensor.

In addition, the program 54 described in the above embodiment is not limited to a program stored in advance in the storage section 52 of the image forming apparatus 1. For example, the program 54 may be a transaction target by itself. In this case, the program 54 may be provided in a downloadable form via a network such as the Internet, or may be provided in a state of being recorded on a computer-readable recording medium such as a CD-ROM.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
a detection element including a receiving section that receives a specific signal, and an output section that outputs a predetermined output value based on the specific signal received by the receiving section, and
a hardware processor, wherein
the hardware processor determines, in accordance with a status of an output from the output section, a state of deterioration that leads to a state in which the detection element needs to be replaced.

2. The image forming apparatus according to claim 1, wherein
the detection element outputs an output signal having a predetermined output value when detecting a specific state, and
the hardware processor determines, according to a state of an output value output as the output signal, a deterioration state of the detection element until the detection element reaches a replacement timing.

3. The image forming apparatus according to claim 1, wherein
the hardware processor measures a tolerance of the detection element to electromagnetic wave noise based on the output value, and
the hardware processor determines a deterioration state of the detection element based on the tolerance.

4. The image forming apparatus according to claim 2, wherein
the hardware processor determines a deterioration state of the detection element based on a state from when the detection element detects the specific state to when the output value is determined.

5. The image forming apparatus according to claim 1, wherein
the hardware processor distinguishes and determines a quasi-failure state and a failure state of the detection element as the deterioration state of the detection element.

6. The image forming apparatus according to claim 2, wherein
the detection element includes a light projector and a light receiver, and
the light receiver outputs the output signal in accordance with an amount of light received when the light receiver receives light emitted from the light projector.

7. The image forming apparatus according to claim 6, wherein
the hardware processor repeatedly samples, at a predetermined cycle, a logical value based on the output signal output from the light receiver, and determines a deterioration state of the detection element based on a logical change until the logical value indicates a predetermined value for multiple consecutive times.

8. The image forming apparatus according to claim 7, wherein
the hardware processor counts the mismatch occurrence number in which the logical value does not match a predetermined value in a period until the logical value continuously indicates the predetermined value for multiple times, and determines a deterioration state of the detection element based on the mismatch occurrence number.

9. The image forming apparatus according to claim 7, wherein
the hardware processor counts the inversion number of the logical value in a period until the logical value indicates a predetermined value for multiple consecutive times, and determines a deterioration state of the detection element based on the inversion number of times.

10. The image forming apparatus according to claim 7, wherein
the hardware processor calculates a mismatch occurrence probability that the logical value does not match a predetermined value in a period until the logical value indicates the predetermined value for multiple consecutive times, and determines a deterioration state of the detection element based on the mismatch occurrence probability.

11. The image forming apparatus according to claim 7, wherein
the hardware processor repeatedly performs, multiple times, detection processing of detecting a logical change until the logical value indicates a predetermined value multiple times in succession, calculates a mismatch occurrence probability that the logical value does not match the predetermined value in multiple times of detection processing, and determines a deterioration state of the detection element based on the mismatch occurrence probability.

12. The image forming apparatus according to claim 6, wherein
the hardware processor measures an output current flowing through the light receiver, and determines a deterioration state of the detection element based on a measurement result of the output current.

13. The image forming apparatus according to claim 12, wherein
the hardware processor changes a current flowing through the light projector, repeatedly samples a logical value based on the output signal output from the light receiver in a predetermined cycle, and measures an output current flowing through the light receiver based on a logical change until the logical value indicates a predetermined value multiple times in succession.

14. The image forming apparatus according to claim 12, wherein
the hardware processor changes a pull-up resistor connected to the light receiver, repeatedly samples a logical value based on the output signal output from the light receiver in a predetermined cycle, and measures an output current flowing through the light receiver based on a logical change until the logical value indicates a predetermined value for multiple consecutive times.

15. The image forming apparatus according to claim 7, wherein
the hardware processor repeatedly samples, at a predetermined cycle, a logical value based on the output signal outputted from the light receiver, and measures an output current flowing through the light receiver and determines a state of deterioration of the detection element based on a result of the measurement of the output current, if mismatch occurrence number in which the logical value does not match a predetermined value is a predetermined number of times or more in a period until the logical value consecutively indicates the predetermined value multiple times.

16. The image forming apparatus according to claim 1, further comprising:
a communicator that communicates with an external apparatus, wherein
the hardware processor decides, based on information received from the external apparatus, whether or not to determine a deterioration state of the detection element, and determines the deterioration state of the detection element in accordance with a determination result.

17. The image forming apparatus according to claim 1, wherein
the hardware processor decides whether or not to determine a deterioration state of the detection element by detecting electromagnetic wave noise, and determines the deterioration state of the detection element in accordance with a determination result.

18. The image forming apparatus according to claim 6, wherein
the hardware processor determines whether or not the life extension processing of the detection element is possible based on the deterioration state of the detection element, and executes the life extension processing of the detection element when it is determined that the life extension processing of the detection element is possible.

19. The image forming apparatus according to claim 18, wherein
the hardware processor executes life extension processing of the detection element by increasing a current flowing through the light projector.

20. The image forming apparatus according to claim 18, wherein
the hardware processor executes life extension processing of the detection element by greatly changing a pull-up resistor connected to the light receiver.

21. A deterioration state determination method for determining, in an image forming apparatus including a detection element that outputs an output signal, a deterioration state of the detection element, comprising:
detecting a state of the output signal; and
determining a deterioration state of the detection element until the detection element reaches a replacement timing, according to a state of the output signal.

22. A non-transitory computer-readable recording medium having recorded thereon a program to be executed in an image forming apparatus including a detection element that outputs an output signal,
the program causing the image forming apparatus to perform:
detecting a state of the output signal; and
determining a deterioration state of the detection element until the detection element reaches a replacement timing, according to a state of the output signal.
